(19) United States
(12) Patent Application Publication
(10) Pub. No.: US 2013/0087079 A1
(43) Pub. Date: Apr. 11, 2013

(54) High Speed Mixing Process for Producing Inorganic Polymer Products

(71) Applicants: Russ Majors, San Marcos, TX (US); Marc-Andre Tardif, Atlanta, GA (US); Russell L. Hill, San Antonio, TX (US); Zhaozhou Zhang, Shanghai (CN); Mark Hollett, San Antonio, TX (US); Li Ai, San Antonio, TX (US)

(72) Inventors: Russ Majors, San Marcos, TX (US); Marc-Andre Tardif, Atlanta, GA (US); Russell L. Hill, San Antonio, TX (US); Zhaozhou Zhang, Shanghai (CN); Mark Hollett, San Antonio, TX (US); Li Ai, San Antonio, TX (US)

(73) Assignee: BORAL MATERIAL TECHNOLOGIES INC., San Antonio, TX (US)

(21) Appl. No.: 13/268,211

(22) Filed: Oct. 7, 2011

(51) Int. Cl. C04B 7/32; B29C 39/00; C04B 18/06

(52) U.S. Cl. 106/695; 106/708; 106/707; 264/241

(57) ABSTRACT

Methods of producing inorganic polymer products are described herein. The methods include mixing reactants comprising a reactive powder, an activator, and optionally a retardant for a mixing time of 15 seconds or less to provide a reaction mixture and forming the reaction mixture into a product. Also described herein are building materials formed according to the methods.

### BACKGROUND

Certain building materials can be prepared from cementitious mixtures based on portland cement and can contain additives to enhance the properties of the materials. Fly ash is used in cementitious mixtures to provide enhanced durability and reduced permeability of the cementitious products. In addition to imparting improved performance properties, the use of fly ash is desirable because it is a recyclable product and would otherwise be a waste material. Thus, there is a desire to provide high strength building products that are based on fly ash.

### SUMMARY

Methods of producing inorganic polymer products are described. The method includes mixing water and reactants comprising a reactive powder, an activator, and optionally a retardant for a mixing time of 15 seconds or less to provide a reaction mixture and forming the reaction mixture into a product. In some examples, the reaction mixture after the mixing step is substantially homogenous. The mixing time can be, for example, from 2 seconds to 10 seconds. In some examples, the mixing is performed at ambient temperature. The forming step can include molding the reaction mixture into the product. For example, the molding step can include wet casting of the product. The method can further include allowing the product to set. The setting time for the allowing step can be, for example, less than 5 minutes (e.g., less than 4 minutes or less than 3 minutes).

The reactive powder includes fly ash and can additionally include portland cement, slag, calcium aluminate cement, or a mixture of these. The reactive powder can include greater than 85% by weight fly ash (e.g., greater than 90% by weight or greater than 95% by weight). In some examples, the fly ash includes a calcium oxide content of from 18% to 35% by weight (e.g., from 23% to 30% by weight). The fly ash present in the reactive powder can include Class C fly ash. In some examples, greater than 75%, greater than 85%, or greater than 95% of the fly ash comprises Class C fly ash. The reactive powder can further include portland cement in an amount of 5% by weight or less (e.g., 3% by weight or less or 1% by weight or less). In some examples, the reactive powder can include 5% by weight or less of calcium aluminate cement.

In some embodiments, the activator used to prepare the inorganic polymers includes citric acid and sodium hydroxide. Optionally, the citric acid and sodium hydroxide are combined prior to mixing with the reactants. The weight ratio of the citric acid to sodium hydroxide can be from 0.4:1 to 2.0:1 (e.g., from 1.0:1 to 1.6:1). In some examples, the activator is present in an amount of from 1.5% to 8.5% based on the weight of the reactive powder. Optionally, a retardant (e.g., borax, boric acid, gypsum, phosphates, gluconates, or a mixture of these) is included as a reactant. The retardant can be present, for example, in an amount of from 0.4% to 7.5% based on the weight of the reactive powder. In some examples, the reactants are substantially free from retardants. In some examples, the reactants are provided at a water to binder ratio of less than 0.15.

The method can further include adding aggregate, such as lightweight aggregate, to the reactants. In some embodiments, the method can include adding a water reducer, a plasticizer (e.g., clay or a polymer), a pigment, or a blowing agent to the reactants.

Also described are products formed according to the methods described herein. The products can be, for example, building materials such as roofing tiles, ceramic tiles, synthetic stone, thin bricks, bricks, pavers, panels, or underlay.

The details of one or more embodiments are set forth in the description below. Other features, objects, and advantages will be apparent from the description and from the claims.

### DETAILED DESCRIPTION

High speed mixing methods for producing inorganic polymers are described herein. The method includes mixing water and reactants comprising a reactive powder, an activator, and optionally a retardant for a mixing time of 15 seconds or less to provide a reaction mixture. The method further includes forming the reaction mixture into a product.

The reactive powder is a reactant used to produce the inorganic polymer products described herein. The reactive powder for use in the reactions includes fly ash. Fly ash is produced from the combustion of pulverized coal in electrical power generating plants. Fly ash produced by coal-fueled power plants is suitable for use in reactive powder described herein. The fly ash can include Class C fly ash, Class F fly ash, or a mixture thereof. As such, the calcium content of the fly ash can vary. In some examples, the fly ash included in the reactive powder can have a calcium content, expressed as the oxide form (i.e., calcium oxide), of from 18% to 35% by weight. For example, the calcium oxide content of the fly ash can be from 23% to 30% by weight.

In some examples, the majority of the fly ash present is Class C fly ash (i.e., greater than 50% of the fly ash present is Class C fly ash). In some examples, greater than 75%, greater than 85%, or greater than 95% of the fly ash present is Class C fly ash. For example, greater than 75%, greater than 76%, greater than 77%, greater than 78%, greater than 79%, greater than 80%, greater than 81%, greater than 82%, greater than 83%, greater than 84%, greater than 85%, greater than 86%, greater than 87%, greater than 88%, greater than 89%, greater than 90%, greater than 91%, greater than 92%, greater than 93%, greater than 94%, greater than 95%, greater than 96%, greater than 97%, greater than 98%, or greater than 99% of the fly ash present is Class C fly ash. In some embodiments, only Class C fly ash is used. In some embodiments, blends of Class C fly ash and Class F fly ash can be used, particularly if the overall CaO content is as discussed above.

The fly ash used in the reactive powder can be a fine fly ash. The use of a fine fly ash provides a higher surface area. As used herein, fine fly ash refers to fly ash having an average particle size of 25 microns or less. The average particle size for the fly ash can be from 5 microns to 25 microns or from 10 microns to 20 microns.

Optionally, the fly ash is the principal component of the reactive powder. In some examples, the fly ash is present in an amount of greater than 85% by weight of the reactive powder, greater than 90% by weight of the reactive powder, or greater than 95% by weight of the reactive powder. For example, the fly ash can be present in an amount of greater than 85% by weight, greater than 86% by weight, greater than 87% by weight, greater than 88% by weight, greater than 89% by weight, greater than 90% by weight, greater than 91% by weight, greater than 92% by weight, greater than 93% by weight, greater than 94% by weight, greater than 95% by weight, greater than 96% by weight, greater than 97% by weight, greater than 98% by weight, or greater than 99% by weight based on the weight of the reactive powder.

The reactive powder for use as a reactant to form the inorganic polymer products can further include cementitious components, including portland cement, calcium aluminate cement, and/or slag. Optionally, portland cement can be included as a component of the reactive powder. Suitable types of portland cement include, for example, Type I ordinary portland cement (OPC), Type II OPC, Type III OPC, Type IV OPC, Type V OPC, low alkali versions of these portland cements, and mixtures of these portland cements. In these examples, no more than 10% by weight of portland cement is included in the reactive powder. In some examples, the reactive powder includes 5% by weight or less, 3% by weight or less, or 1% by weight or less of portland cement. For example, the reactive powder can include portland cement in an amount of 10% or less by weight, 9% or less by weight, 8% or less by weight, 7% or less by weight, 6% or less by weight, 5% or less by weight, 4% or less by weight, 3% or less by weight, 2% or less by weight, 1% or less by weight, or 0.5% or less by weight. In some examples, the reactive powder is substantially free from portland cement. For example, the reactive powder can include less than 0.1% by weight, less than 0.01% by weight, or less than 0.001% by weight of portland cement based on the weight of the reactive powder. In some embodiments, the reactive powder includes no portland cement.

Optionally, calcium aluminate cement (i.e., high aluminate cement) can be included in the reactive powder. In some examples, the calcium aluminate cement is present in an amount of 10% or less by weight of the reactive powder. For example, the reactive powder can include calcium aluminate cement in an amount of 10% or less, 9% or less, 8% or less, 7% or less, 6% or less, 5% or less, 4% or less, 3% or less, 2% or less, 1% or less, 0.9% or less, 0.8% or less, 0.7% or less, 0.6% or less, 0.5% or less, 0.4% or less, 0.3% or less, 0.2% or less, or 0.1% or less by weight. In some examples, the reactive powder can include calcium aluminate cement in an amount of from 0.5% to 5%, from 1% to 4.5%, or from 2% to 4% by weight. In some examples, the reactive powder is substantially free from calcium aluminate cement or includes no calcium aluminate cement.

The reactive powder can also include a ground slag such as blast furnace slag in an amount of 10% or less by weight. For example, the reactive powder can include slag in an amount of 10% or less, 9% or less, 8% or less, 7% or less, 6% or less, 5% or less, 4% or less, 3% or less, 2% or less, or 1% or less by weight.

The reactive powder can also include calcium sources such as limestone (e.g., ground limestone), quicklime, slaked lime, or hydrated lime in an amount of 10% or less by weight of the reactive powder. For example, limestone can be present in an amount of 10% or less, 9% or less, 8% or less, 7% or less, 6% or less, 5% or less, 4% or less, 3% or less, 2% or less, or 1% or less by weight of the reactive powder.

The reactive powder can also include a tricalcium aluminate additive. As would be understood by those skilled in the art, tricalcium aluminate is present in a small amount in portland cement. The tricalcium aluminate would be present as an additive, wherein the tricalcium aluminate is not a portland cement constituent. The tricalcium aluminate additive can be present in an amount of from 0.1% to 10% by weight, or 1% to 5% of the reactive powder.

Anhydrous calcium sulfate can be optionally included as an additional reactant used to form the inorganic polymer compositions described herein. The anhydrous calcium sulfate can be present as a reactant in an amount of 0.1% by weight or greater based on the weight of the reactive powder and has been found to increase the compressive strength of the inorganic polymer products. In some examples, the anhydrous calcium sulfate can be present in an amount of from 1% to 10%, 2% to 8%, 2.5% to 7%, or 3% to 6% by weight of the reactive powder. For example, the amount of anhydrous calcium sulfate can be 0.5% or greater, 1% or greater, 1.5% or greater, 2% or greater, 2.5% or greater, 3% or greater, 3.5% or greater, 4% or greater, 4.5% or greater, or 5% or greater based on the weight of the reactive powder.

An activator is a further reactant used to form the inorganic polymer products described herein. The activator allows for rapid setting of the inorganic polymer products and also imparts compressive strength to the products. The activator can include one or more of acidic, basic, and/or salt components. For example, the activator can include citrates, hydroxides, metasilicates, carbonates, aluminates, sulfates, and/or tartrates. The activator can also include other multifunctional acids that are capable of complexing or chelating calcium ions (e.g., EDTA). Specific examples of suitable citrates for use as activators include citric acid and its salts, including, for example, sodium citrate and potassium citrate. Specific examples of suitable tartrates include tartaric acid and its salts (e.g., sodium tartrate and potassium tartrate). In some examples, the activator can include alkali metal hydroxides, such as sodium hydroxide and potassium hydroxide. Further examples of suitable activators include metasilicates (e.g., sodium metasilicate and potassium metasilicate); carbonates (e.g., sodium carbonate and potassium carbonate); aluminates (e.g., sodium aluminate and potassium aluminate); and sulfates (e.g., sodium sulfate and potassium sulfate). In some examples, the activator includes citric acid, tartaric acid, or mixtures thereof. In some examples, the activator includes sodium hydroxide. In some examples, the activator includes a mixture of citric acid and sodium hydroxide. In examples including a mixture of citric acid and sodium hydroxide, the weight ratio of citric acid present in the mixture to sodium hydroxide present in the mixture is from 0.4:1 to 2.0:1, 0.6:1 to 1.9:1, 0.8:1 to 1.8:1, 0.9:1 to 1.7:1, or 1.0:1 to 1.6:1. The activator components can be pre-mixed prior to being added to the other reactive components in the inorganic polymer or added separately to the other reactive components. For example, citric acid and sodium hydroxide could be combined to produce sodium citrate and the mixture can include possibly one or more of citric acid and sodium hydroxide in stoichiometric excess. In some embodiments, the activator includes a stoichiometric excess of sodium hydroxide. The total amount of activators can include less than 95% by weight of citrate salts. For example, the total amount of activator can include from 25-85%, 30-75%, or 35-65% citrate salts by weight. The mixture in solution and the mixture when combined with reactive powder can have a pH of from 12 to 13.5 or about 13.

The activator can be present as a reactant in an amount of from 1.5% to 8.5% dry weight based on the weight of the reactive powder. For example, the activator can be present in an amount of from 2% to 8%, from 3% to 7%, or from 4% to 6%. In some examples, the activator can be present in an amount of 1.5%, 2%, 2.5%, 3%, 3.5%, 4%, 4.5%, 5%, 5.5%, 6%, 6.5%, 7%, 7.5%, 8%, or 8.5% dry weight based on the weight of the reactive powder. For example, when sodium hydroxide and citric acid are used as the activators, the amount of sodium hydroxide used in the activator solution can be from 0.3 to 15.6, 0.5 to 10, 0.75 to 7.5, or 1 to 5 dry parts by weight based on the weight of reactive powder and the amount of citric acid used in the activator solution can be from 0.25 to 8.5, 0.5 to 0.7, 0.75 to 0.6, or 1 to 4.5 dry parts by weight based on the weight of reactive powder. The resulting activator solution can include sodium citrate and optionally one or more of citric acid or sodium hydroxide.

The activator can be provided, for example, as a solution. In some examples, the activator can be provided in water as an aqueous solution in a concentration of from 10% to 50% or from 20% to 40% based on the weight of the solution. For example, the concentration of the activator in the aqueous solution can be from 25% to 35% or from 28% to 32% based on the weight of the solution. Examples of suitable concentrations for the activator in the aqueous solution include 10%, 15%, 20%, 25%, 30%, 35%, 40%, 45%, or 50% based on the weight of the solution.

The reactants used to form the inorganic polymer products can further include a retardant. Retardants are optionally included to prevent the product from stiffening too rapidly, which can result in a reduction of strength in the structure. Examples of suitable retardants for inclusion as reactants include borax, boric acid, gypsum, phosphates, gluconates, or a mixture of these. The retardant can be provided in solution with the activator (e.g., borax or boric acid) and/or can be provided as an additive with the reactive powder (e.g., gypsum). In some examples, the retardant is present in an amount of from 0.4% to 7.5% based on the weight of the reactive powder. For example, the retardant can be present in an amount of from 0.5% to 5%, 0.6% to 3%, 0.7 to 2.5%, or 0.75% to 2.0% based on the weight of the reactive powder. In some embodiments, when gypsum is used as a retardant, it is used in an amount of 3% by weight or less based on the weight of the reactive powder. In some embodiments, borax is used as the retardant. When citric acid and sodium hydroxide are used as the activators, the weight ratio of borax to sodium hydroxide can be 0.3:1 to 1.2:1 (e.g., 0.8:1 to 1.0:1). In some examples, lower ratios of 0.3:1 to 0.8:1 can be the result of including an additional retardant such as gypsum. In some examples, the product is substantially free from retardants or includes no retardants.

The reactants described herein can optionally include less than 3.5% by weight of additional sulfates. As would be understood by those skilled in the art, sulfates are present in the fly ash. Thus, “additional sulfates” refers to sulfates other than those provided by the fly ash. In some examples, the composition can include less than 3.5% by weight of sulfates based on the amount of reactive powder other than those provided by the fly ash. For example, the composition can include less than 3.5% by weight, less than 3% by weight, less than 2.5% by weight, less than 2% by weight, less than 1.5% by weight, less than 1% by weight, or less than 0.5% by weight of sulfates based on the amount of reactive powder other than those provided by the fly ash. In some examples, the composition is substantially free from additional sulfates. For example, the composition can include less than 0.1% by weight, less than 0.01% by weight, or less than 0.001% by weight of additional sulfates based on the amount of reactive powder. In some embodiments, the composition includes no additional sulfates.

When present, the additional sulfates can be provided in the form of gypsum (i.e., calcium sulfate dihydrate). As described above, gypsum can be present in the composition as a retardant. In some examples, the composition includes gypsum in an amount of less than 3.5% by weight based on the amount of reactive powder. For example, the composition can include gypsum in an amount of less than 3.5% by weight, less than 3% by weight, less than 2.5% by weight, less than 2% by weight, less than 1.5% by weight, less than 1% by weight, or less than 0.5% by weight.

The method further includes adding water to the reactants. The water can be provided to the reactants by providing the activator and optionally the retardant in solution and/or by adding water directly to the reactants. In some examples, the temperature of the water added to the reactants is ambient temperature. The solution to binder or solution to reactive powder weight ratio (i.e., the ratio of the solution including activator and optionally the retardant to reactive powder) can be from 0.12:1 to 0.5:1, depending on the product being made and the process being used for producing the product. The water to reactive powder (or water to binder) ratio can be from 0.06:1 to 0.4:1, depending on the product being made and the process being used for producing the product. In some embodiments, the water to binder ratio can be from 0.06:1 to 0.17:1, from 0.09:1 to less than 0.15:1, or from 0.095:1 to less than 0.14:1. In some embodiments, the water to binder ratio is less than 0.15:1. In some embodiments, the water to binder ratio can be from 0.15:1 to 0.4:1, particularly when aggregate is used that absorbs a significant amount of water or solution (e.g., 20-30%). In some embodiments, the water to binder ratio is from 0.15:1 to 0.25:1 or can be from 0.25 to 0.4:1. The water to binder ratio can be 0.06:1, 0.07:1, 0.08:1, 0.09:1, 0.10:1, 0.11:1, 0.12:1, 0.13:1, 0.14:1, 0.15:1, 0.16:1, 0.17:1, 0.18:1, 0.19:1, 0.20:1, 0.21:1, 0.22:1, 0.23:1, 0.24:1, 0.25:1, 0.26:1, 0.27:1, 0.28:1, 0.29:1, 0.30:1, 0.31:1, 0.32:1, 0.33:1, 0.34:1, 0.35:1, 0.36:1, 0.37:1, 0.38:1, 0.39:1, or 0.40:1.

The inorganic polymer can have a calcia to silica molar ratio of from 0.6:1 to 1.1:1. For example, the calcia to silica molar ratio can be 0.6:1, 0.7:1, 0.8:1, 0.9:1, 1.0:1 or 1.1:1.

In some examples, the reactants are substantially free from alkanolamines. As used herein, alkanolamines refer to mono-, di-, and tri-alcohol amines (e.g., monoethanolamine, diethanolamine, and triethanolamine) In some examples, the reactants include no alkanolamines.

One or more aggregates or fillers can be further used in the inorganic polymer products described herein. In some examples, the aggregate includes lightweight aggregate. Examples of suitable lightweight aggregate includes bottom ash, expanded clay, expanded shale, expanded perlite, vermiculite, volcanic tuff, pumice, hollow ceramic spheres, hollow plastic spheres, expanded plastic beads (e.g., polystyrene beads), ground tire rubber, and mixtures of these. Further examples of suitable aggregates and fillers include other types of ash such as those produced by firing fuels including industrial gases, petroleum coke, petroleum products, municipal solid waste, paper sludge, wood, sawdust, refuse derived fuels, switchgrass, or other biomass material; ground/recycled glass (e.g., window or bottle glass); milled glass; glass spheres; glass flakes; activated carbon; calcium carbonate; aluminum trihydrate (ATH); silica; sand; alluvial sand; natural river sand; ground sand; crushed granite; crushed limestone; silica fume; slate dust; crusher fines; red mud; amorphous carbon (e.g., carbon black); clays (e.g., kaolin); mica; talc; wollastonite; alumina; feldspar; bentonite; quartz; garnet; saponite; beidellite; granite; calcium oxide; calcium hydroxide; antimony trioxide; barium sulfate; magnesium oxide; titanium dioxide; zinc carbonate; zinc oxide; nepheline syenite; perlite; diatomite; pyrophillite; flue gas desulfurization (FGD) material; soda ash; trona; soy meal; pulverized foam; and mixtures thereof.

In some embodiments, inorganic fibers or organic fibers can be included in the inorganic polymer products, e.g., to provide increased strength, stiffness, or toughness. In some examples, fire resistant or retardant glass fibers can be included to impart fire resistance or retarding properties to the inorganic polymer products. Fibers suitable for use with the inorganic polymer products described herein can be provided in the form of individual fibers, fabrics, rovings, or tows. Exemplary fibers include glass, polyvinyl alcohol (PVA), carbon, basalt, wollastonite, and natural (e.g., bamboo or coconut) fibers. The fibers can be included in an amount of 0.1% to 6% based on the weight of reactive powder. For example, the fibers can be included in an amount of 0.5% to 5%, 0.75% to 4%, or 1% to 3% based on the weight of reactive powder.

The inclusion of aggregate or filler in the inorganic polymer products described herein can modify and/or improve the chemical and mechanical properties of the products. For example, the optimization of various properties of the products allows their use as building materials and in other structural applications. High aggregate and filler loading levels can be used in combination with the reaction mixture without a substantial reduction of (and potentially an improvement in) the intrinsic structural and physical properties of the inorganic polymer products. Further, the use of lightweight aggregate provides lightweight building products without compromising the mechanical properties of the inorganic polymer products.

The aggregate or filler can be added to the reaction mixture at a weight ratio of 0.5:1 to 4.0:1 based on the weight of reactive powder (i.e., aggregate to binder weight ratio). In some embodiments, the aggregate to binder weight ratio can be from 0.5:1 to 2.5:1 or from 1:1 to 2:1 depending on the product to be produced. In some embodiments, the aggregate to binder weight ratio can be from 1.5:1 to 4:1 or from 2:1 to 3.5:1. For example, the aggregate to binder weight ratio can be 0.5:1, 0.6:1, 0.7:1, 0.8:1, 0.9:1, 1.0:1, 1.1:1, 1.2:1, 1.3:1, 1.4:1, 1.5:1, 1.6:1, 1.7:1, 1.8:1, 1.9:1, 2.0:1, 2.1:1, 2.2:1, 2.3:1, 2.4:1, 2.5:1, 2.6:1, 2.7:1, 2.8:1, 2.9:1, 3.0:1, 3.1:1, 3.2:1, 3.3:1, 3.4:1, 3.5:1, 3.6:1, 3.7:1, 3.8:1, 3.9:1, or 4.0:1.

Additional components that can be added to the reactants as described herein include water reducers, plasticizers, pigments, foaming agents (e.g., air-entraining agents) or blowing agents, anti-efflorescence agents, photocatalysts, ultraviolet light stabilizers, fire retardants, antimicrobials, and antioxidants.

Water reducers can be included in the reactants described herein to reduce the amount of water in the reaction mixture while maintaining the workability, fluidity, and/or plasticity of the reaction mixture. In some examples, the water reducer is a high-range water reducer, such as, for example, a superplasticizer admixture. Examples of suitable water reducers include lignin, naphthalene, melamine, polycarboxylates, lignosulfates and formaldehyde condensates (e.g., sodium naphthalene sulfonate formaldehyde condensate). Water reducers can be provided in an amount of from greater than 0 to 1% by weight based on the weight of reactive powder.

Plasticizers can also be included in the reactants described herein. Plasticizers enhance the extrudability of the inorganic polymer products. Examples of suitable plasticizers include clays (e.g., bentonite, expanded clay, and kaolin clay) and polymers (e.g., JEFFSPERSE X3202, JEFFSPERSE X3202RF, and JEFFSPERSE X3204, each commercially available from Huntsman Polyurethanes; Geismar, La.).

Pigments or dyes can optionally be added to the reactants described herein. An example of a pigment is iron oxide, which can be added in amounts ranging from 1 wt % to 7 wt % or 2 wt % to 6 wt %, based on the weight of reactive powder.

Foaming and/or blowing agents can be added to the reactants described herein to produce a foamed product. Foaming agents can be used to help the system maintain air or other gases, e.g., from the mixing process. Examples of suitable foaming agents include sodium alkyl ether sulfate, ammonium alkyl ether sulfate, sodium alpha olefin sulfonate, sodium deceth sulfate, ammonium deceth sulfate, sodium laureth sulfate, and sodium dodecylbenzene sulfonate. Blowing agents can be included in the reactants to produce a gas and generate a foamed product. Examples of suitable blowing agents include aluminum powder, sodium perborate, and H₂O₂. The foaming agents and/or blowing agents can be provided in an amount of 0.1% or less based on the weight of the reactive powder.

Anti-efflorescence agents can be included with the reactants to limit the transport of water through the structure and thus limit the unbound salts that are brought to the surface of the structure thereby limiting the aesthetic properties of the structure. Suitable anti-efflorescence agents include siloxanes, silanes, stearates, amines, fatty acids (e.g., oleic acid and linoleic acid), organic sealants (e.g., polyurethanes or acrylics), and inorganic sealants (e.g., polysilicates). Anti-efflorescence agents can be included with the reactants in an amount of from 0.01 wt % to about 1 wt % based on the weight of the reactive powder.

Photocatalysts such as anatase (titanium dioxide) can be used that produce superoxidants that can oxidize NOₓ and VOC's to reduce pollution. The photocatalysts can make the system super hydrophobic and self-cleaning (e.g., in the presence of smog). These materials can also act as antimicrobials and have impact on algae, mold, and/or mildew growth.

Ultraviolet (UV) light stabilizers, such as UV absorbers, can be added to the reactants described herein. Examples of UV light stabilizers include hindered amine type stabilizers and opaque pigments like carbon black powder. Fire retardants can be included to increase the flame or fire resistance of the products. Antimicrobials, such as copper complexes, can be used to limit the growth of mildew and other organisms on the surface of the products. Antioxidants, such as phenolic antioxidants, can also be added. Antioxidants can provide increased UV protection, as well as thermal oxidation protection.

The reactants and optionally any additional components as described herein are then mixed for a mixing time of 15 seconds or less to provide a reaction mixture. In some examples, the reactants can be mixed from 2 seconds to 10 seconds (e.g., from 4 to 10 seconds). The mixing times, even in the order of 15 seconds or less, result in a substantially homogenous reaction mixture. The mixing can be performed at an elevated temperature (e.g., up to 160° F.) or at ambient temperature. In some embodiments, the mixing occurs at ambient temperature.

The reaction mixtures can be produced using a batch, semi-batch, or continuous process. At least a portion of the mixing step, reacting step, or both, can be conducted in a mixing apparatus such as a high speed mixer or an extruder. The method can further include the step of extruding the resulting reaction mixture through a die or nozzle. In examples where the activator includes more than one component, the components can be pre-mixed prior to reacting with the reactive powder and optionally the retardant, as noted above. In some embodiments, a mixing step of the method used to prepare the reaction mixtures described herein includes: (1) combining the activators in either solid form or aqueous solution (e.g., combining an aqueous solution of citric acid with an aqueous solution of sodium hydroxide) and adding any additional water to provide a desired concentration for the activator solution; (2) optionally pre-mixing the reactive powder and any additional components; and (3) mixing the activator solution with the reactive powder, aggregate and any additional components.

An ultrasonic or vibrating device can be used for enhanced mixing and/or wetting of the various components described herein. Such enhanced mixing and/or wetting can allow a high concentration of reactive powder to be mixed with the other reactants. The ultrasonic or vibrating device produces an ultrasound of a certain frequency that can be varied during the mixing and/or extrusion process. Alternatively, a mechanical vibrating device can be used. The ultrasonic or vibrating device useful in the preparation of products described herein can be attached to or adjacent to the mixer. In some examples, the ultrasonic or vibrating device can be adjacent to the feed of the mixer, thereby facilitating the feed of the materials into the mixer. In some examples, the ultrasonic or vibrating device can be attached to the exit port of an extruder or mixer. An ultrasonic or vibrating device provided at the exit port may provide de-aeration of undesired gas bubbles and better mixing for the other components, such as blowing agents, plasticizers, and pigments. Further, the ultrasonic or vibrating device provided at the exit port of the mixer can decrease the accumulation of material exiting the port.

After mixing the components for less than 15 seconds, the reaction mixture is formed into a product. The forming step includes molding the reaction mixture into a product. In some examples, the reaction mixture is placed in a shaping mold and allowed to cure. For example, the reaction can be allowed to cure in individual molds or it can be allowed to cure in a continuous forming system such as a belt molding system. In some embodiments, the reactive mixture is wet cast to produce the products.

The method can further include allowing the product to set. The product can be allowed to set, for example, in the shaping mold used in the forming step. In some examples, the setting time is less than 5 minutes (e.g., from 1 to 5 minutes or from 2 to 4 minutes). For example, the setting time can be less than 5 minutes, less than 4 minutes, less than 3 minutes, less than 2 minutes, or less than 1 minute.

The inorganic polymer products described herein can be formed into shaped articles and used in various applications, including building materials. Examples of such building materials include roofing tiles (e.g., shake and slate tile), ceramic tiles, synthetic stone, architectural stone, thin bricks, bricks, pavers, panels, underlay (e.g., bathroom underlay), banisters, lintels, pipe, posts, signs, guard rails, retaining walls, park benches, tables, railroad ties, and other shaped articles.

The examples below are intended to further illustrate certain aspects of the methods and products described herein, and are not intended to limit the scope of the claims. Parts and percentages are provided on a weight basis herein, unless indicated otherwise.

### EXAMPLES

Examples of inorganic polymer products as described herein were prepared by mixing a reactive powder, an activator, optionally a retardant, and aggregate.

TABLE 1

| | Exam- | Exam- | Exam- | Exam- |
|---|---|---|---|---|
| Material (parts by weight) | ple 1 | ple 2 | ple 3 | ple 4 |
| Class C Fly Ash | 100.0 | 100.0 | 100.0 | 95.0 |
| Portland Cement | 0.0 | 0.0 | 0.0 | 5.0 |
| Anhydrous Calcium Sulfate | 0.0 | 3.2 | 0.0 | 0.0 |
| Sodium Hydroxide | 1.6 | 1.6 | 1.6 | 1.6 |
| Citric Acid | 1.9 | 1.9 | 1.9 | 1.9 |
| Borax | 0.5 | 0.5 | 0.5 | 0.5 |
| Water | 20.0 | 20.0 | 20.0 | 20.0 |
| Sand | 200.0 | 200.0 | 200.0 | 200.0 |

In Examples 1-3 (Table 1), the reactive powder included Class C fly ash. In Example 4, the reactive powder included Class C fly ash and portland cement. The activator included citric acid and sodium hydroxide, which were combined prior to mixing with the other components. The retarder was borax and sand was used as the aggregate at an aggregate to binder weight ratio of 2:1. The components were mixed for 5 seconds at ambient temperature, fed into molds, and allowed to cure.

The sand that is used as aggregate in the examples can be replaced with a lightweight aggregate (e.g. expanded clay). In using lightweight aggregates, the aggregate to binder weight ratio can be decreased (e.g., to less than 1.5:1 or less then 1:1) so the decrease in the density of the aggregate can be offset by an increase in the amount of binder provided relative to the amount of lightweight aggregate to maintain desired strength.

The reaction mixtures, products, materials, and methods of the appended claims are not limited in scope by the specific reaction mixtures, products, materials, and methods described herein, which are intended as illustrations of a few aspects of the claims and any reaction mixtures, products, materials, and methods that are functionally equivalent are intended to fall within the scope of the claims. Various modifications of the reaction mixtures, products, materials, and methods in addition to those shown and described herein are intended to fall within the scope of the appended claims. Further, while only certain representative materials and method steps disclosed herein are specifically described, other combinations of the materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed.

1. A method of producing an inorganic polymer product, comprising:
mixing water and reactants comprising a reactive powder, an activator, and optionally a retardant for a mixing time of 15 seconds or less to provide a reaction mixture, wherein the reactive powder comprises fly ash; and
forming the reaction mixture into a product.

2. The method of claim 1, wherein the reaction mixture after said mixing step is substantially homogenous.

3. The method of claim 1, wherein the mixing time is from 2 seconds to 10 seconds.

4. The method of claim 1, wherein the mixing is performed at ambient temperature.

5. The method of claim 1, further comprising allowing the product to set.

6. The method of claim 5, wherein the setting time for the allowing step is less than 5 minutes.

7. The method of claim 6, wherein the setting time is less than 4 minutes.

8. The method of claim 6, wherein the setting time is less than 3 minutes.

9. The method of claim 1, wherein the forming step comprises molding the reaction mixture into the product.

10. The method of claim 9, wherein the molding step comprises wet casting of the product.

11. The method of claim 1, wherein the reactive powder further comprises portland cement, slag, calcium aluminate cement, or a mixture of these.

12. The method of claim 1, wherein the reactive powder includes greater than 85% by weight of fly ash.

13. The method of claim 1, wherein the reactive powder includes greater than 95% by weight of fly ash.

14. The method of claim 1, wherein greater than 75% of the fly ash comprises Class C fly ash.

15. The method of claim 1, wherein greater than 95% of the fly ash comprises Class C fly ash.

16. The method of claim 1, wherein the reactive powder includes 5% by weight or less of portland cement.

17. The method of claim 1, wherein the reactive powder includes 5% by weight or less of calcium aluminate cement.

18. The method of claim 1, wherein the activator includes citric acid and sodium hydroxide.

19. The method of claim 18, wherein the citric acid and sodium hydroxide are combined prior to mixing with the reactants.

20. The method of claim 18, wherein the weight ratio of citric acid to sodium hydroxide is from 0.4:1 to 2.0:1.

21. The method of claim 18, wherein the weight ratio of citric acid to sodium hydroxide is from 1.0:1 to 1.6:1.

22. The method of claim 1, wherein the retardant includes borax, boric acid, gypsum, phosphates, gluconates, or a mixture of these.

23. The method of claim 1, wherein the reactants are provided at a water to binder ratio of less than 0.15:1.

24. The method of claim 1, further comprising adding aggregate to the reactants.

25. The method of claim 24, wherein the aggregate includes lightweight aggregate.

26. The method of claim 1, wherein the reactants are substantially free of retardants.

27. A product formed according to the method of claim 1.

28. The product of claim 27, wherein the product is a building material.

29. The product of claim 27, wherein the product is selected from the group consisting of a roofing tile, a ceramic tile, a synthetic stone, a thin brick, a brick, a paver, a panel, or an underlay.
